(19) United States
(12) Patent Application Publication
(10) Pub. No.: US 2011/0187847 A1
(43) Pub. Date: Aug. 4, 2011

(54) SCANNING TYPE CHARGED PARTICLE MICROSCOPE DEVICE AND METHOD FOR PROCESSING IMAGE ACQUIRED WITH SCANNING TYPE CHARGED PARTICLE MICROSCOPE DEVICE

(76) Inventors: Jie Bai, Yokohama (JP); Kenji Nakahira, Fujisawa (JP); Atsushi Miyamoto, Yokohama (JP)

(21) Appl. No.: 13/058,228

(22) PCT Filed: Jul. 3, 2009
(86) PCT No.: PCT/JP2009/062563

§ 371 Date: Apr. 26, 2011

(30) Foreign Application Priority Data
Sep. 8, 2008 (JP) 2008-229216

(51) Int. Cl. H04N 7/18

(52) U.S. Cl. 348/80; 348/E07.085

(57) ABSTRACT

The present method comprises the steps of imaging the sample under different imaging conditions to acquire multiple images, generating degradation functions for the multiple acquired images, and then generating an image with an improved resolution using the multiple acquired images and the degradation functions corresponding to the acquired images to process the image with the improved resolution.

### TECHNICAL FIELD

The present invention relates to a scanning type charged particle microscope device that scans the surface of a sample using charged particles and acquires an image, and a method for processing an image acquired with a scanning type charged particle microscope device. The invention more particularly relates to a method for improving a resolution in order to generate a high-resolution image and an apparatus that generates a high-resolution image.

### BACKGROUND ART

A scanning charged particle microscope is an apparatus that is suitable to measure and observe a pattern formed on a semiconductor wafer. Especially, in a semiconductor manufacturing process, the scanning charged particle microscope is used for the purpose of calculating a characteristic amount of a target sample, for example, for the purpose of inspecting a semiconductor, measuring a pattern or the like. Specifically, the scanning charged particle microscope is used to observe an image, detect a defect occurring on a semiconductor wafer, examine the cause of the defect, and measure the dimensions and shape of a pattern. With reductions in the sizes of patterns, the need to inspect fine defects and measure the patterns with high accuracy is improved. Thus, it is more important to acquire a clear and high-resolution image.

In a conventional technique, however, the resolution and quality of an image may be degraded due to the scanning charged particle microscope or dispersion of a charged particle beam in a sample irradiated with charged particles. The reasons for degradation of the resolution are mainly classified into three regions. The first reason is that the charged particle beam has an intensity waveform corresponding to a diffraction aberration generated due to characteristics of wave motions of the particles, a color aberration caused by characteristics of a lens and a spherical aberration, and is incident on the surface of the sample. The second reason is that the charged particle beam incident on the sample is generally dispersed in the sample and transmits through the sample or emitted from a region larger than a region in which the charged particle beam is incident on the sample. These effects cause degradation of the resolution. The third reason is that imaging conditions are limited due to the material of the sample. For example, when the sample is made of a material (such as an ArF resist) that has a low resistance to an electron beam, it is necessary to image the sample with a low acceleration voltage in order to reduce damage in the sample. However, when the acceleration voltage is reduced, a diffraction aberration and a color aberration are improved, and thereby the resolution is reduced. In order to achieve a high resolution, a technique for improving a resolution on the basis of design of an electron optical system and a technique for improving a resolution on the basis of image processing have been studied.

In the technique for improving a resolution on the basis of design of an electron optical system, an aberration is mainly reduced and whereby the resolution is improved. For example, a technique for reducing an aberration has been proposed in Patent Document 1. In Patent Document 1, accelerating means that uses a boosting voltage is provided to obtain a high-resolution scanning electron microscope image in which a color aberration is reduced.

Regarding the technique for improving a resolution on the basis of image processing, an image restoring technique has been proposed in Patent Document 2. In this technique, the image restoring process is performed using, as a degradation function, a beam intensity distribution obtained from the surface of a sample, and thereby the resolution of an image of the target sample is improved.

Patent Document 3 discloses a technique for using multiple images acquired while in-focus positions are different and combining the images to generate a two-dimensional image that does not include a blur caused by an out-of-focus state in the entire image of the sample imaged.

Patent Document 4 discloses a method for evaluating a resolution using density gradients of local regions of an image.

In addition, Non-Patent Document 1 discloses a multipole lens that is used for a color aberration corrector or the like.

Furthermore, Non-Patent Document 2 discloses a calculation method that is useful to accurately calculate a degradation function.

Non-Patent Document 3 describes that an image fᵢ(x, y) converges to a maximum likelihood solution when noise follows a Poisson distribution in order to update the image fᵢ(x, y) using the Richardson-Lucy method that is widely known as an iterative method.
Patent Document 1: JP-A-9-171791
Patent Document 2: JP-A-3-44613
Patent Document 3: JP-A-2006-190693
Patent Document 4: JP-A-2007-128913
Non-Patent Document 1: J. Zach, “Design of a high-resolution low-voltage scanning electron microscope”, Optik 83, 30 (1989)
Non-Patent Document 2: J. Orloff: Handbook of Charged Particle Optics, CRC Press (1997)
Non-Patent Document 3: A. K. Katsaggelos: Optical Engineering, 28, 7, pp. 735-748 (1989)

### DISCLOSURE OF THE INVENTION

### Problem to be Solved by the Invention

In the aforementioned conventional techniques, however, there is a limit to improve a resolution. For example, in the technique (described in Patent Document 1) for improving a resolution on the basis of an improvement of the electron optical system, there is a physical limit. Thus, effects of a diffraction aberration, a color aberration and a spherical aberration are not completely eliminated, and it is difficult to further improve a resolution.

In the technique described in Patent Document 2, the more the resolution of an image acquired by an imaging system is degraded, the more insufficient the resolution of the image becomes.

In the technique (described in Patent Document 3) for using multiple images acquired while in-focus positions are different and combining the images to generate a two-dimensional image that does not include a blur caused by an out-of-focus state in the entire image of the sample imaged, it is not possible to reduce degradation of the resolution that is caused by a reason other than an out-of-focus state. In addition, in order to image a sample with a thickness without causing an out-of-focus state, it is necessary to acquire many images.

The optimal imaging condition varies depending on the shape, material and the like of the sample. Thus, when the number of images acquired under a specific imaging condition is one, the quality of the image is not sufficient in some cases. For example, when a semiconductor pattern is scanned with an electron beam in a direction parallel to a longitudinal direction of the pattern, an edge portion of the pattern is not irradiated with the electron beam in some cases. In this case, the pattern may not be clearly displayed. Thus, when a sample that includes patterns extending in many directions is scanned with an electron beam, the quality of an acquired image of the sample is not sufficient.

An object of the present invention is to provide a scanning charged particle microscope capable of solving the problems of the aforementioned conventional techniques and acquiring an image with a higher resolution than a single image simply acquired, and a method for processing an image acquired by a scanning charged particle microscope.

### Means for Solving the Problem

In order to solve the problems, in the present invention, a scanning charged particle microscope images a sample while changing a condition corresponding to a cause affecting a resolution, acquires multiple images, and generates a single image with an improved resolution using the multiple images.

In the present invention, a method for improving the resolution of an image acquired by imaging a sample using a scanning charged particle microscope and for processing the image is to image the sample under different imaging conditions, acquire multiple images, generate degradation functions for the multiple acquired images, and then generate an image with an improved resolution using the multiple acquired images and the degradation functions corresponding to the acquired images to process the image with the improved resolution.

According to the present invention, the scanning charged particle microscope includes: image acquiring means for irradiating and scanning a sample with a focused charged particle beam, detecting secondary charged particles generated from the sample to image the sample, and acquiring images of the sample; image acquiring condition controlling means for controlling the image acquiring means so that the image acquiring means acquires multiple images under different imaging conditions; degradation function generating means for generating degradation functions for the images acquired under the different imaging conditions by the image acquiring means controlled by the image acquiring condition controlling means; high-resolution image generating means for generating an image with an improved resolution using the images that is acquired under the different imaging conditions by the image acquiring means controlled by the image acquiring condition controlling means, and the degradation functions that is generated by the degradation function generating means and corresponds to the acquired images; and image processing means for processing the image with the resolution improved by the high-resolution image generating means.

### Effect of the Invention

According to the present invention, the scanning charged particle microscope is capable of acquiring an image with a resolution that is higher than an image acquired under a single imaging condition that has been simply set. The scanning charged particle microscope processes the image. Thus, it is possible to observe a fine structure and calculate a characteristic amount of a target sample with high accuracy.

### BRIEF DESCRIPTION OF THE DRAWINGS

FIG. 1 is a flowchart of an example of a process of generating a single image with an improved resolution from multiple images acquired under different conditions.

FIG. 2 is a diagram showing an example of an outline structure of an SEM.

FIGS. 3(a) to 3(c) are diagrams showing the case in which a low boosting voltage is applied.

FIGS. 4(a) to 4(c) are diagrams showing the case in which a high boosting voltage is applied.

FIG. 5 is a diagram showing procedures of a process that is performed using two or more images.

FIG. 6 is a diagram showing an example of a resolution improving process that is performed on images acquired while changing an acceleration voltage applied to an electron beam.

FIG. 7 is a diagram showing an example of the resolution improving process that is performed using multiple images acquired while changing a scanning direction of an electron beam.

FIG. 8 is a diagram showing an example of the resolution improving process that is performed using multiple images acquired while changing a frequency distribution of an intensity waveform of a beam incident on the surface of a sample.

FIG. 9 is a diagram showing an example of the resolution improving process that is performed using multiple images acquired while changing the shape of an electron beam incident on the surface of the sample.

FIGS. 10(a) to 10(d) are diagrams each showing a spreading angle of an electron beam, a depth of focus and the relationship between the height of the sample and a resolution.

FIG. 11 is a diagram showing an example of the resolution improving process that is performed using multiple images acquired while changing the spreading angle of the electron beam and thereby changing the depth of focus.

FIGS. 12(a) and 12(b) are diagrams each showing an example in which repeated patterns that are located at different positions are imaged.

FIG. 13 is a diagram showing an example in which an image combining process is performed to combine multiple acquired images, a degradation function combining process is performed to combine degradation functions corresponding to the acquired images and generate a combined degradation function, and a resolution improving process is performed using the combined image and the combined degradation function.

FIG. 14 is a diagram showing an example of a resolution improving process in which restoring processes are performed on the multiple acquired images using the degradation functions corresponding to the multiple acquired images, and the multiple restored images are combined.

FIG. 15 is a diagram showing an example of a resolution improving process in which a combining and restoring process is performed on the multiple acquired images using the degradation functions corresponding to the multiple acquired images.

FIGS. 16(a) and 16(b) are diagrams each showing an example of an image restoring process that is performed on the basis of an iterative method, while FIG. 16(a) shows the case in which the image restoring process is performed using a single input image and a single degradation function, and FIG. 16(b) shows the case in which the image restoring process is performed using multiple input images and multiple degradation functions.

FIG. 17 is a diagram showing procedures of the image combining process.

FIG. 18 is a diagram showing other procedures of the image combining process.

FIG. 19 is a diagram showing procedures of the degradation function combining process.

FIG. 20 is a diagram showing an example of an interface that switches an imaging condition on the basis of design data and sample information.

FIG. 21 is a diagram showing a GUI screen that prompts a user to set an imaging condition.

FIG. 22 is a diagram showing an example of a process in which the shape and dimensions of a pattern are measured using an image with an improved resolution.

FIG. 23 is a diagram showing an example of a process in which a defect is detected and classified using the image with the improved resolution.

FIG. 24 is a diagram showing an example in which the resolution improving process is performed after the multiple acquired images are positioned.

### DESCRIPTION OF THE REFERENCE NUMERALS

101 . . . Image acquiring step
102 . . . Degradation function generating step
103 . . . Resolution improving step
21 . . . Acquiring unit
22 . . . Input/output unit
23 . . . Control unit
24 . . . Processing unit
25 . . . Storage unit
200 . . . Electron beam
201 . . . Deflected electron beam
202 . . . Electron gun
203 . . . Alignment coil
204 . . . Condenser lens
205 . . . Astigmatic correction coil
206, 207 . . . Deflector
208 . . . Boosting electrode
209 . . . Objective lens
210 . . . Objective lens diaphragm
211, 212 . . . Detector (reflected electron detector, secondary electron detector)
213 . . . Image generator
214 . . . Sample
215 . . . XY stage
271 . . . Design data reading unit
272 . . . Positioning unit
273 . . . Image quality improving unit

### BEST MODE FOR CARRYING OUT THE INVENTION

An embodiment of the present invention describes a scanning electron microscope (hereinafter referred to as an SEM) that is one of scanning charged particle microscopes. The embodiment of the present invention is not limited to this, and a scanning ion microscope (SIM) may be used in the embodiment of the present invention.

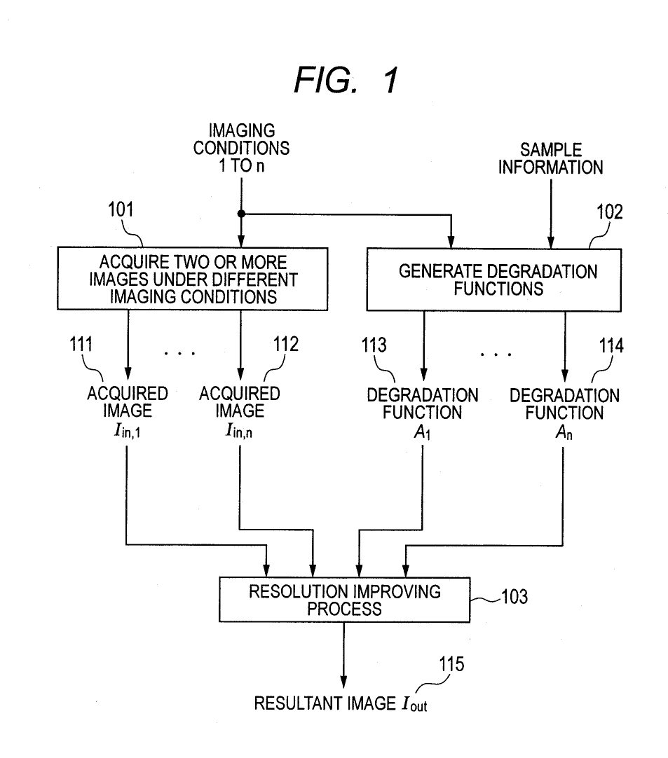

FIG. 1 is a flowchart showing an example of a process of generating a single image with an improved resolution from two or more images acquired under different imaging conditions. A number n of images (images I_{in, 1} (indicated by 111) to images I_{in, n}(indicated by 112)) are acquired under different imaging conditions in an image acquiring step 101 (n≧2). Examples of the imaging conditions that can be changed for each of the images to be acquired are a boosting voltage, an acceleration voltage, a scanning method, the intensity waveform of an electron beam, the shape of the electron beam, the depth of focus, and the position of a repeated pattern.

Next, in a degradation function generating step 102, a number n of degradation functions A₁ (indicated by 113) to Aₙ (indicated by 114) that correspond to the images I_{in, 1} to I_{in, n} are generated on the basis of sample information and the imaging conditions used for imaging. The degradation functions are functions that indicate degrees of degradations of resolutions. The number n of degradation functions may be different from each other. Also, some of the degradation functions may be the same. Lastly, in a resolution improving step 103, a resolution improving process is performed using the images I_{in, 1} to I_{in, n} and the degradation functions A₁ to Aₙ corresponding to the images I_{in, 1} to I_{in, n} so that a resultant image Iₒᵤₜ 115 (image with an improved resolution) is obtained. The different imaging conditions may be determined using information on design data as described later. Also, an interface may be provided, which allows a user to determine the different imaging conditions.

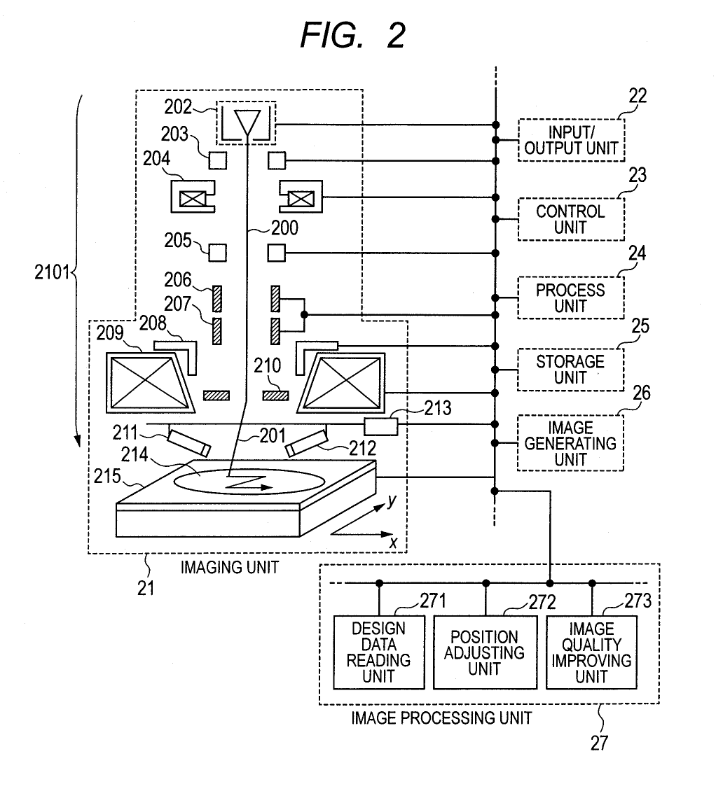

FIG. 2 is a diagram showing an example of an outline structure of the SEM according to the present invention. The SEM includes an imaging unit 21, an input/output unit 22, a control unit 23, a processing unit 24, a storage unit 25, an image processing unit 26 and the like. The imaging unit 21 has an electron optical system 2101. The electron optical system 2101 of the imaging unit 21 includes an electron source 202, an alignment coil 203, a condenser lens 204, an astigmatic correction coil 205, deflectors 206, 207, a boosting electrode 208, an objective lens 209, an objective lens diaphragm 210, detectors 211, 212 and the like. The alignment coil 203 aligns a primary electron beam 200 emitted by the electron source 202. The condenser lens 204 focuses the primary electron beam 200. The astigmatic correction coil 205 corrects astigmatism of the primary electron beam 200. The deflectors 206, 207 two-dimensionally deflect the primary electron beam 200 so as to form a deflected primary electron beam 201. The detectors 211, 212 detect secondary electrons (including reflected electrons) generated from a sample 214 irradiated with the deflected primary electron beam 201. The image processing unit 26 includes a design data reading unit 271, a positioning unit 272, an image quality improving unit 273 and the like. When the sample is imaged while the imaging conditions and the position of a part (to be imaged) of the sample are changed, images acquired by imaging the sample may be misaligned. In this case, it is necessary that the positioning unit 272 position the multiple images before a single image is generated using the multiple images. After that, the image quality improving unit 273 performs a process of improving the qualities of the images so as to generate a single high-resolution image from the number n of acquired images.

The sample 214 such as a wafer is placed on an XY stage 215. The sample 214 is moved by the XY stage 215 in X and Y directions. Thus, any part of the surface of the sample 214 can be imaged so that an image of the part of the sample surface is acquired. The detectors 211, 212 detect secondary electrons generated from the sample 214 so as to obtain a signal. The signal is converted into a digital signal by an A/D converter 213. The image generating unit 26 generates a digital image (hereinafter referred to as an image) from the digital signal. One of the detectors 211, 212 may be a reflected electron detector that detects a large amount of reflected electrons, while the other of the detectors 211, 212 may be a secondary electron detector that detects a large amount of secondary electrons.

The control unit 23 controls a periphery of the electron source 202 included in the electron optical system 2101 of the imaging unit 21; the alignment coil; the astigmatic correction coil 205; a voltage to be applied to the boosting electrode 208; the positions of focal points of electron lenses (e.g., the condenser lens 204 and the objective lens 209) for focusing the beam; the position of the stage 215; a timing for an operation of the A/D converter 213; generation of an image in the image generating unit 26; and the like. The processing unit 24 generates degradation functions in step 102 (shown in FIG. 1), performs a resolution improving process in step 103 (shown in FIG. 2) and the like. Images that are acquired by the image processing unit 26 are stored in the storage unit 25. The processing unit 24 processes the images and generates the degradation functions, while the processed images, the generated degradation functions, the imaging conditions, the sample information and the like are stored in the storage unit 25. Design data is received by the input/output unit 22. The acquired images or the processed images are output from the input/output unit 22. Also, the degradation functions and the like are output from the input/output unit 22.

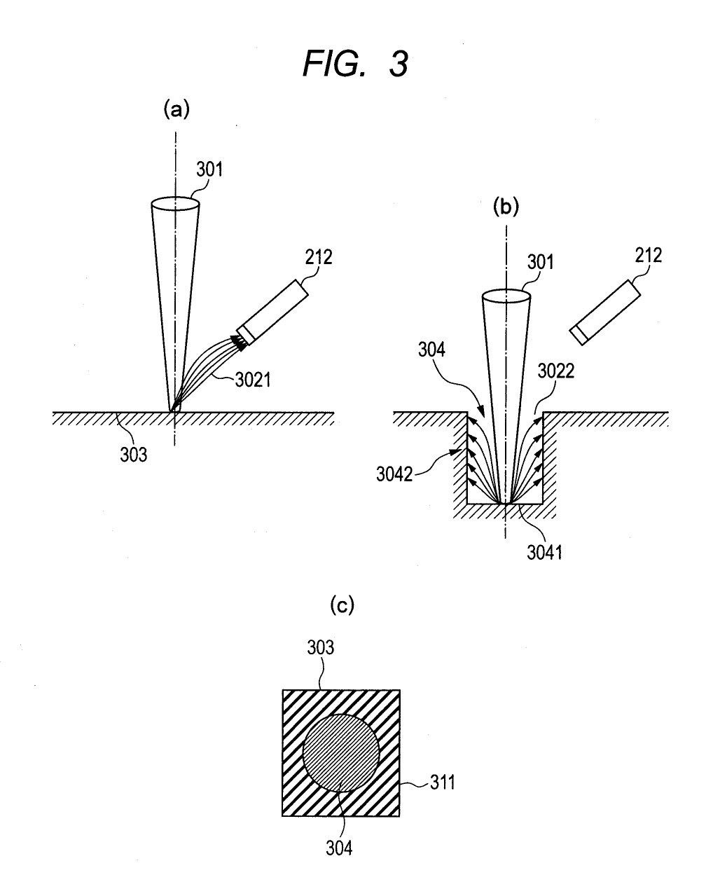

Next, an example in which the imaging conditions that are used for the SEM according to the present invention are changed is described with reference to FIGS. 3(a) to 9.

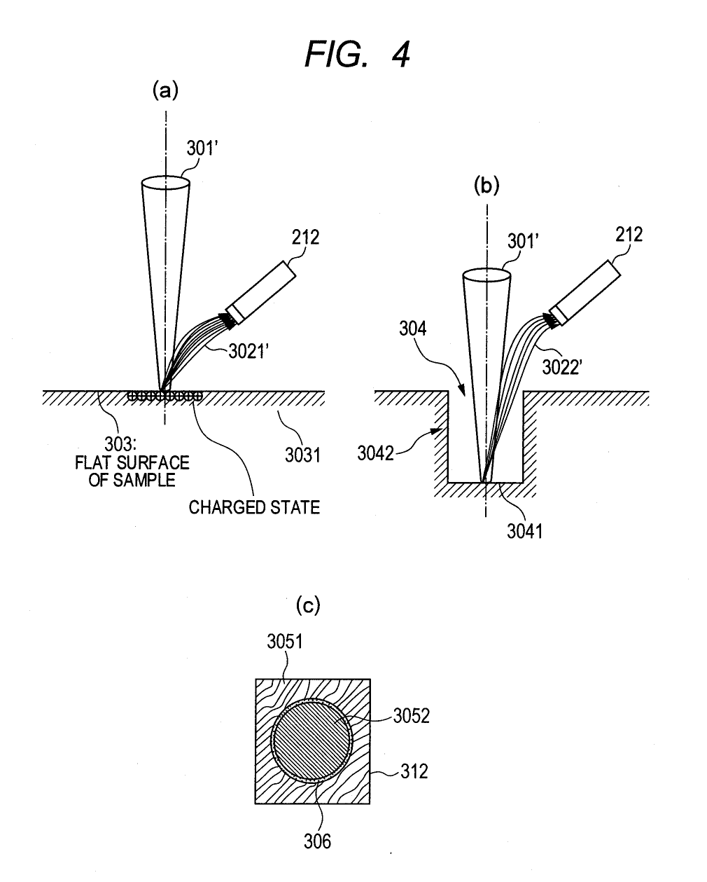

An example in which two images are acquired (n=2) is described below. The present invention is not limited to this example. Three or more images may be acquired (n≧3). First, an example in which the boosting electrode 208 according to the present invention is controlled to change a boosting voltage is described with reference to FIGS. 3(a) to 5. The boosting voltage that is applied by the boosting electrode 208 is used to attract a large amount of the secondary electrons and the like. When the sample has a contact hole, changing the boosting voltage makes it possible to acquire a large amount of information on the contact hole. FIGS. 3(a) to 3(c) show a change in secondary electrons and a change in an acquired image when a low boosting voltage is applied to image the sample that has the contact hole. FIGS. 4(a) to 4(c) show a change in secondary electrons and a change in an acquired image when a high boosting voltage is applied to image the sample that has the contact hole.

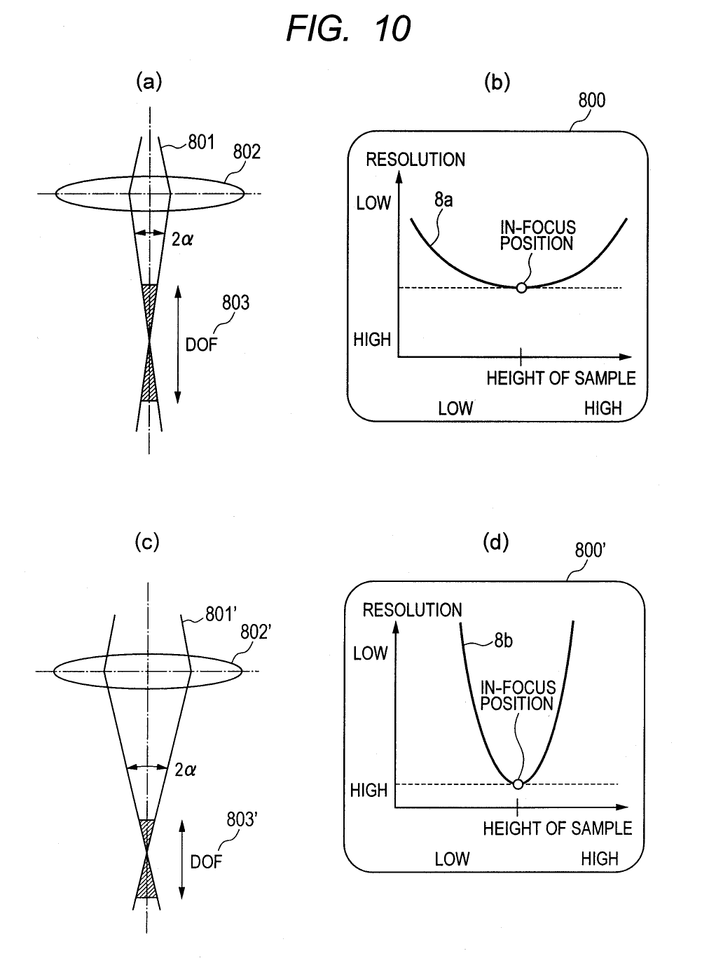

In FIGS. 3(a) to 3(c), when the low boosting voltage is applied, secondary electrons 3021 that are emitted from a flat region 303 of the surface of the sample are detected by the secondary electron detectors 211 and 212 as shown in FIG. 3(a). The secondary electron detectors 211 and 212 obtain signals by detecting the secondary electrons 3021. The image generating unit 26 receives the signals from the secondary electron detectors 211 and 212 and generates a clear, high-quality and high-resolution image 311 on the basis of the received signals. In contrast, secondary electrons 3022 that are emitted from a bottom surface 3041 of the contact hole reach a wall 3042 of the contact hole 304 and are not detected by the secondary electron detectors 211 and 212 as shown in FIG. 3(b). Thus, in the acquired image 311 shown in FIG. 10(c), a pattern of the bottom surface 3041 of the contact hole cannot be viewed.

As shown in FIGS. 4(a) to 4(c), when the high boosting voltage is applied to the boosting electrode 208, secondary electrons 3022′ that are emitted from the bottom surface 3041 of the contact hole are attracted and detected by the secondary electron detectors 211 and 212 as shown in FIG. 4(b). As a result of the detection, a clear and high-quality image 312 shown in FIG. 4(c) is acquired. In the image 312, the bottom surface 3041 of the contact hole is clearly viewed. When the high boosting voltage is applied, a large number of electrons that are present in the flat region 303 of the surface of the sample and an internal region 3031 of the sample are attracted. Thus, the surface 303 of the sample is easily charged. In the image 312 shown in FIG. 4(c), an image 3051 of a pattern formed on the flat region 303 of the surface of the sample may be distorted, and an irregularity of light may be present in an image 3052 of the flat region 303 of the surface of the sample.

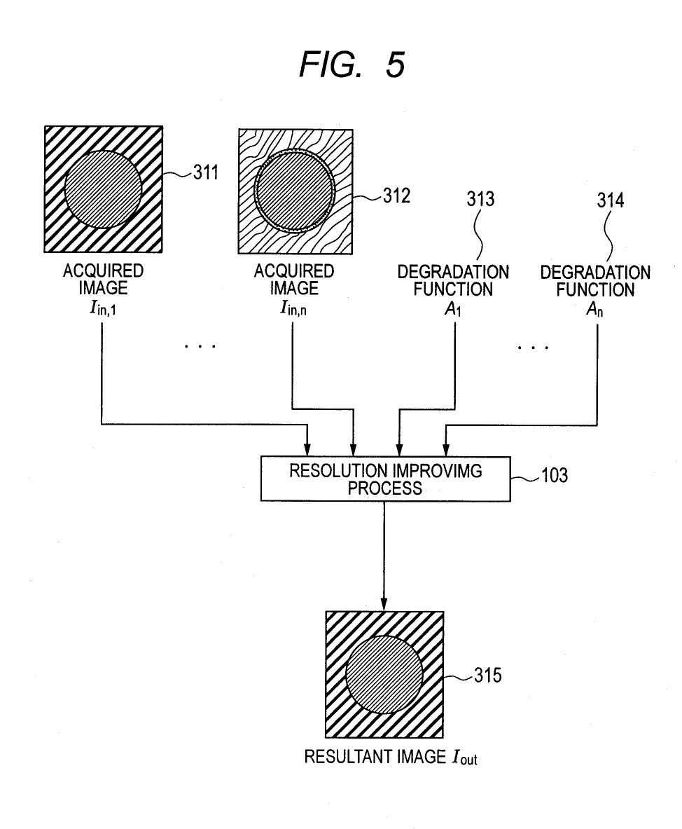

FIGS. 5(a) to 5(c) show procedures of a process that is performed in the case in which two or more images are acquired in the present embodiment. In the present embodiment, the resolution improving process 103 is performed using the following information: information obtained when the low boosting voltage is applied to image the flat region 303 of the surface of the sample; and information obtained when the high boosting voltage is applied to image the bottom surface 3041 of the contact hole. Then, a clear and high-quality resultant image Iₒᵤₜ 315 is acquired. In the resultant image Iₒᵤₜ 315, an image part of the flat region 303 of the surface of the sample and an image part of the bottom surface 3041 of the contact hole are clearly viewed. The boosting voltage is changed between 0 kV and 10 kV, for example. However, the boosting voltage is not limited to the range of 0 kV to 10 kV.

Next, an example in which an acceleration voltage that is applied to the primary electron beam 200 is changed according to the present invention is described. The acceleration voltage is a voltage that is applied to a space between the electron gun 202 and the sample 214. When the acceleration voltage is changed, the following are changed: a depth that electrons propagate in the sample; a region in which the electrons are dispersed and spread; and the like.

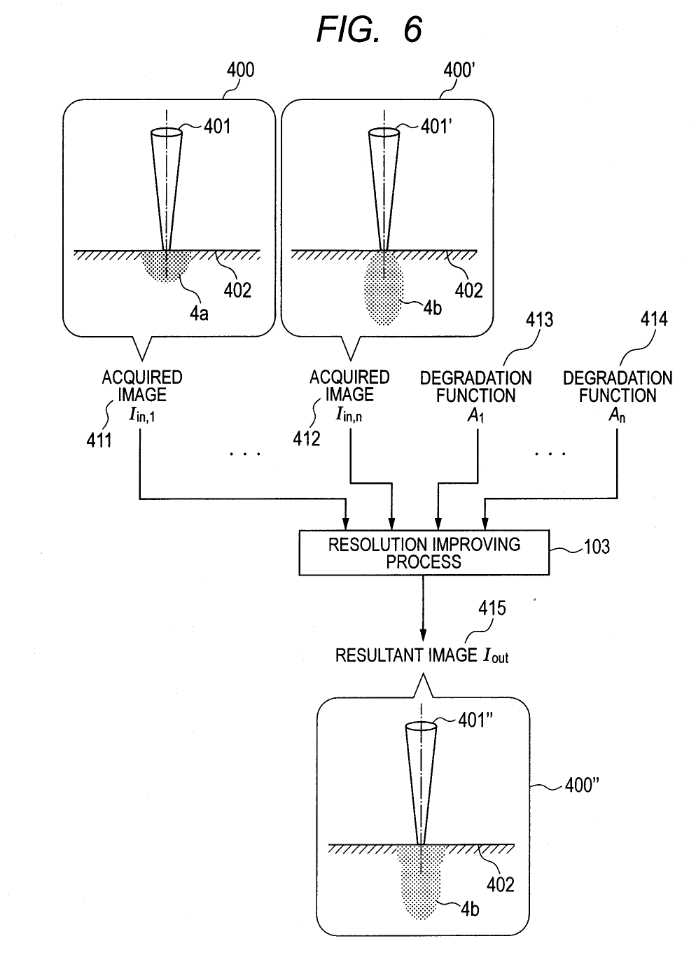

In FIG. 6, schematic diagrams 400 and 400′ are shown. The schematic diagrams 400 and 400′ each show a cross section of the sample. The schematic diagram 400 shows a depth that an electron beam 401 propagates in the sample when a low acceleration voltage is applied. In addition, the schematic diagram 400 shows a region in which the electron beam 401 is dispersed and spread when the low acceleration voltage is applied. The schematic diagram 400′ shows a depth that an electron beam 401′ propagates in the sample when a high acceleration voltage is applied. In addition, the schematic diagram 400′ shows a region in which the electron beam 401′ is dispersed and spread when the high acceleration voltage is applied. The schematic diagram 400 shows the case in which the low acceleration voltage is applied and the diameter of the electron beam 401 with which the surface 402 of the sample is irradiated is improved. Reference numeral 4a indicates a region in which electrons are dispersed in the sample when the low acceleration voltage is applied. In other words, the depth that the electrons propagate in the sample is small, the region in which the electrons are spread is small, and the electrons are sensitive to information on the surface of the sample. Thus, in an image acquired when the low acceleration voltage is applied, the surface of the sample is clearly viewed.

In contrast, when the high acceleration voltage is applied, a depth that electrons propagate in the sample is improved as shown in the schematic diagram 400′ showing the cross section of the sample. A region 4b in which the electrons are dispersed and spread in the sample is improved when the high acceleration voltage is applied. Thus, a large amount of information on a deep portion of the sample can be acquired. In an image acquired in this case, the deep portion of the sample is clearly viewed. As the acceleration voltage is higher, the diameter of the beam incident on the surface 402 of the sample is reduced and the resolution of an edge portion of a pattern formed on the surface 402 of the sample is improved. In the process according to the present invention, while information included in the two acquired images remains as much as possible, the resolution improving process 103 is performed to acquire a resultant image Iₒᵤₜ 415. Thus, in the resultant image Iₒᵤₜ 415, a large amount of information on the surface 402 of the sample and a large amount of information on the deep portion of the sample can be represented. The acceleration voltage may be changed between 100 kV and 50 kV. The acceleration voltage is not limited to the range of 100 kV to 50 kV.

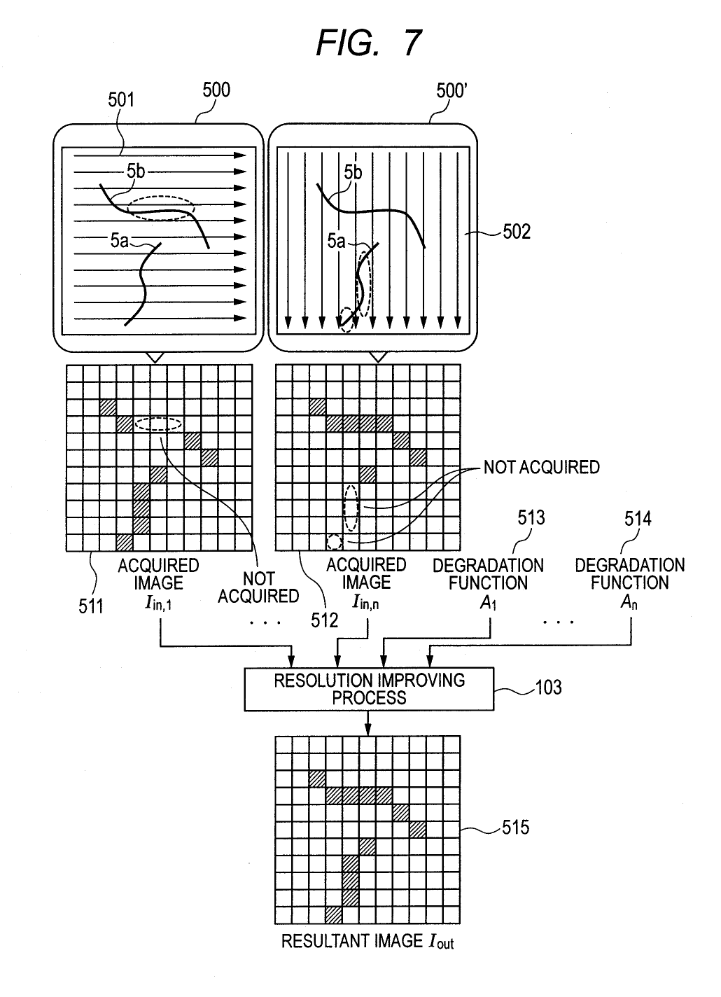

Next, an example in which a scanning direction of the electron beam is changed according to the present invention is described with reference to FIG. 7. When the scanning direction is fixed to one direction and parallel to the pattern formed on the surface 402 of the sample, there is a case that an edge portion of the pattern is not irradiated with the electron beam. In this case, the pattern may not be clearly displayed. In order to solve this problem, the sample is scanned using the beam in multiple directions in this example.

FIG. 7 shows the case in which the scanning direction of the electron beam is a lateral direction and the case in which the scanning direction of the electron beam is a longitudinal direction. A schematic diagram 500 shows the case in which the surface of the sample is scanned using the electron beam in the lateral direction. In the schematic diagram 500, since the scanning direction 501 is the lateral direction, a sufficient signal that indicates an edge of a pattern 5a extending in the longitudinal direction (perpendicular to the beam scanning direction 501) can be acquired. However, a signal that indicates an edge of a pattern 5b extending in the lateral direction (parallel to the beam scanning direction 501) cannot be acquired. In an image Iᵢₙ 511 acquired in this case, the pattern 5a is clearly displayed and a part that is included in the pattern 5b and extends in the lateral direction is not displayed.

A schematic diagram 500′ shows the case in which the surface of the sample is scanned using the electron beam in the longitudinal direction. When the beam scanning direction 502 is the longitudinal direction, an image of the pattern 5b that extends in the lateral direction (perpendicular to the beam scanning direction 502) can be clearly acquired. A part of the pattern 5a that extends in the longitudinal direction (parallel to the beam scanning direction 502) is not displayed. In this example, the resolution improving process 103 is performed using the following: the image 511 acquired by scanning the surface of the sample in the lateral direction 501 using the electron beam as shown in the schematic diagram 500; the image 512 acquired by scanning the surface of the sample in the longitudinal direction 502 using the electron beam as shown in the schematic diagram 500′; and the degradation functions 513 and 514. Thus, a clear and high-resolution resultant image 515 can be acquired by the resolution improving process 103, while the pattern 5a extending in the longitudinal direction and the pattern 5b extending in the lateral direction are clearly displayed in the resultant image 515.

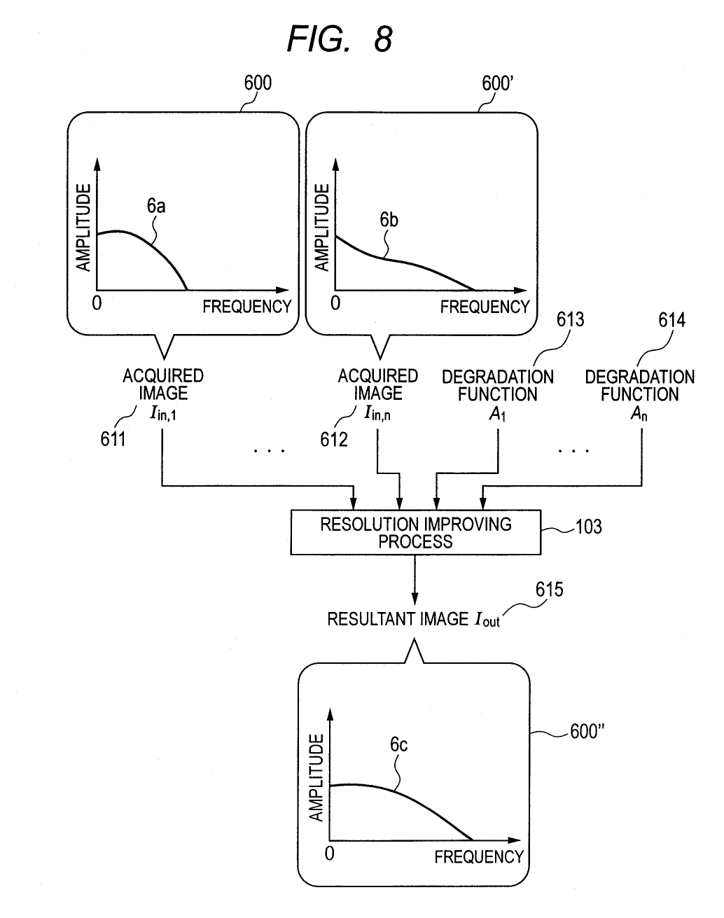

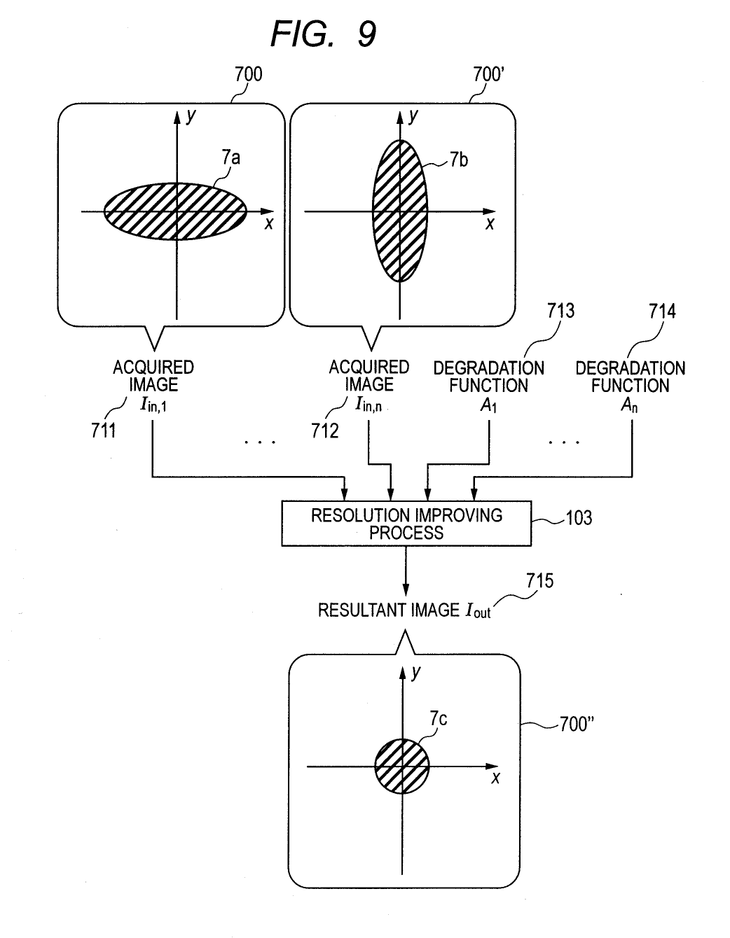

Next, an example in which a frequency distribution of the intensity waveform of the beam incident on the surface of the sample is changed according to the present invention is described with FIG. 8. In graphs 600 and 600′, the abscissa indicates a frequency, and the ordinate indicates the amplitude of the intensity waveform of the beam. The frequency distribution of the intensity waveform of the beam incident on the surface of the sample can be changed on the basis of a spreading angle of the electron beam, for example. Conditions under which a large amount of information on low frequencies can be acquired are different from conditions under which a large amount of information on high frequencies. It is difficult to acquire a large amount of information on all frequencies from a single acquired image. The graph 600 shows an example of a frequency distribution 6a of the intensity waveform of the beam incident on the surface of the sample, while the frequency distribution 6a is obtained in the state in which a large amount of information on low frequencies can be acquired. The graph 600′ shows an example of a frequency distribution 6b of the intensity waveform of the beam incident on the surface of the sample, while the frequency distribution 6b is obtained in the state in which a large amount of information on high frequencies can be acquired. Through the resolution improving process 103 according to the present embodiment, a resultant image Iₒᵤₜ 615 that includes a large amount of a low frequency information component and a large amount of a high frequency information component can be acquired.

Next, an example in which the diameter of the electron beam incident on the surface of the sample is changed according to the present invention is described with reference to FIG. 9. When the multipole lens that is disclosed in Non-Patent Document 1 and used for a color aberration corrector or the like is used, the intensity waveform of the beam is not rotationally symmetric, and the diameter of the beam in a specific direction can be reduced.

In a diagram 700 showing a cross section shape 7a of the beam, the diameter of the beam in the longitudinal direction is small. In a diagram 700′ showing a cross section shape 7b of the beam, the diameter of the beam in the lateral direction is small. The surface of the sample is imaged under imaging conditions that correspond to the cross sectional shapes of the beams so that images 711 and 712 are acquired. After the acquisition, the process is performed preferentially using degradation functions 713, 714 and information on the images acquired with the beams that each has the smaller diameter in an edge direction so that a reluctant image Iₒᵤₜ 715 can be acquired. The reluctant image Iₒᵤₜ 715 corresponds to a cross sectional shape 7c of the beam highly focused in all directions in a diagram 700″ showing a cross section of the beam.

Next, an example in which the depth of focus is changed according to the present invention is described with reference to FIGS. 10(a) to 10(d). When the beam is focused on a certain point on the sample that has a certain thickness, a region on which the beam is not focused is present. A range of the height of the sample that causes the degree of a blur caused by the out-of-focus state to be in a certain range is called the depth of focus (DOF). FIG. 10(a) shows the cross sectional shape of the electron beam, taken along the direction of an optical axis when the depth of focus is large. FIG. 10(b) shows the relationship between a resolution and the height of the sample when the depth of focus is large. FIG. 10(c) shows the cross sectional shape of the electron beam, taken along the direction of the optical axis when the depth of focus is small. FIG. 10(d) shows the relationship between a resolution and the height of the sample when the depth of focus is small. In FIG. 10(a), an electron beam 801 is focused by an objective lens 802. When an aperture angle α of the lens is small, the depth 803 of focus (DOF) is large. A graph 800 shown in FIG. 10(b) shows the relationship between the vertical direction of the sample and the resolution when a specific in-focus portion of the sample is imaged. When the aperture angle α of the lens is small, degradation of the resolution of an image of a sample portion located far from the in-focus portion is relatively small.

In contrast, when the aperture angle of the lens is large as shown in FIG. 10(c), a resolution that corresponds to the in-focus portion is improved as shown in FIG. 10(d). The sample that has the thickness is imaged when the aperture angle is large. In addition, the sample that has the thickness is imaged when the aperture angle is small. When comparing above two images, the image which is taken under the condition of the aperture angle is large, a resolution that corresponds to a sample portion located near the in-focus portion is high. When the image which is taken under the condition of the aperture angle is small, a resolution that corresponds to a sample portion located far from the in-focus portion is high.

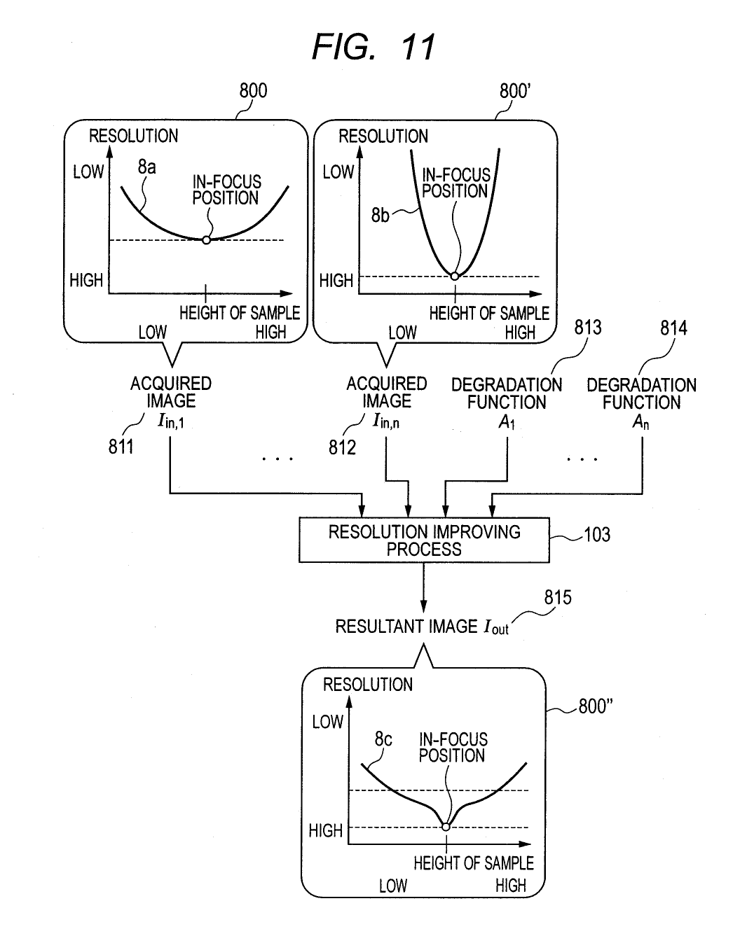

In this example, while the aperture angle α is changed, the sample is imaged so that multiple images 811 and 812 are acquired as shown in graphs 800 and 800′ of FIG. 11. After the acquisition, information on high-resolution images of portions of the sample surface is used so that an image that has high-resolution image portions of all portions of the sample surface can be generated as shown in a graph 800″.

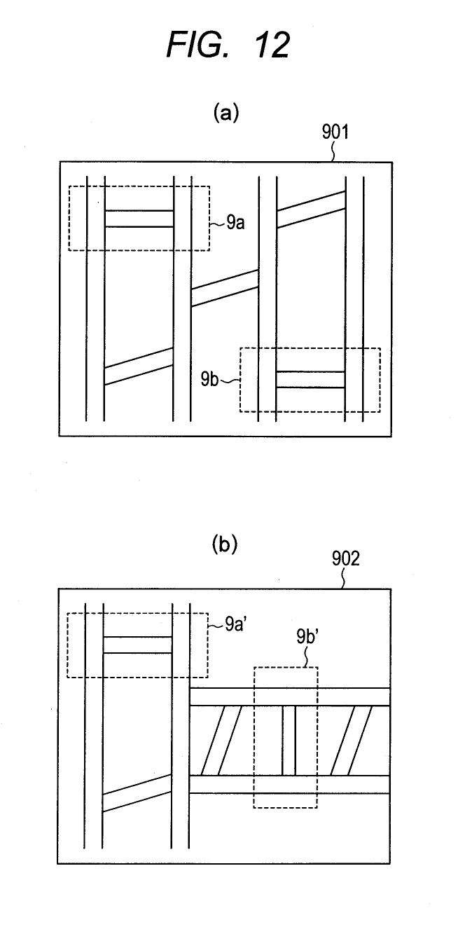

Next, an example in which repeated patterns that are included in a sample and located at different positions are imaged is described with reference to FIGS. 12(a) and 12(b). In the examples shown in FIGS. 3(a) to 11, the multiple images of the same portion of the sample are acquired, while the imaging conditions are changed. However, when the same portion is repeatedly imaged, contamination or the like may occur due to a contaminated object or the like that is present in the microscope. In addition, a resist pattern may shrink in a material (such as an ArF resist) that has a low resistance to an electron beam. This example describes that when a sample that has a repeated pattern is to be imaged, different sample portions are imaged in order to prevent contamination and shrinkage.

FIGS. 12(a) and 12(b) show examples. In the example shown in FIG. 12(a), a target pattern 9a of a sample 901 is first imaged, and a pattern 9b that has the same shape as the pattern 9a is next imaged. In this example, the pattern 9b to be imaged for the second or later time is located by moving in parallel the target pattern 9a to be imaged for the first time. In the example shown in FIG. 12(b), a target pattern 9a′ of a sample 902 is first imaged, and a pattern 9b′ that has the same shape as the pattern 9a′ is next imaged. In this example, the pattern 9b′ to be imaged for the second or later time is located by moving in parallel and rotating the target pattern 9a′ to be imaged for the first time. This prevents the quality of an image from being reduced due to contamination, shrinkage and the like and allows the repeated patterns and the like to be clearly observed.

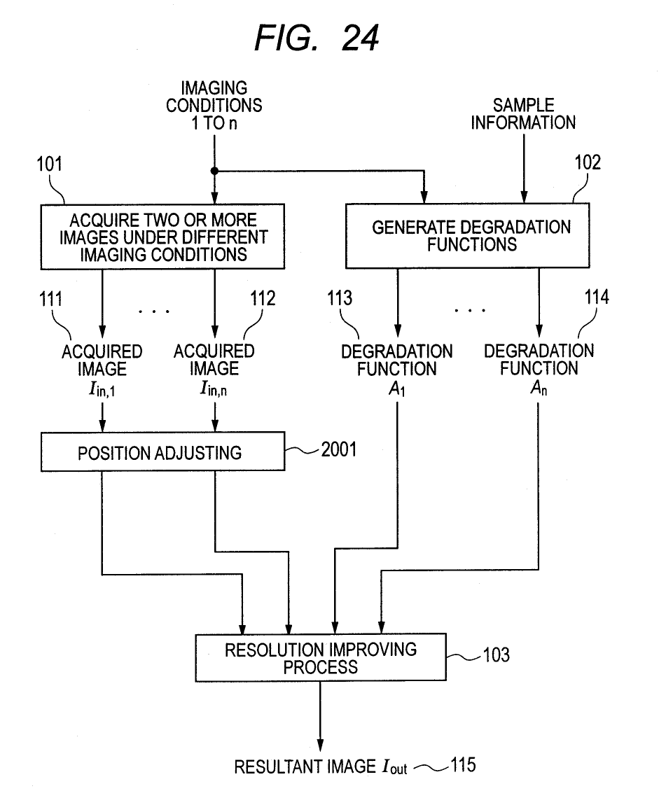

Next, an example in which the resolution improving process is performed after positioning of multiple images is described with reference to FIG. 24. The process 102 (shown in FIG. 24) of generating degradation functions and the resolution improving process 103 (shown in FIG. 24) are performed in the same manner as the processes 102 and 103 described with reference to FIG. 1. First, the sample is imaged under different imaging conditions so that multiple images are acquired in step 101. After the acquisition, the acquired images are positioned in a positioning process 2001. Then, the resolution improving process 103 is performed using the degradation functions 113, 114 (generated in the process 102 of generating degradation functions) and the multiple images positioned in the positioning process 2001 so that a resultant image Iₒᵤₜ 115 is acquired. When different sample portions are imaged as shown in FIGS. 12(a) and 12(b), it is considered that the positions of the acquired images may be misaligned depending on the changed imaging conditions. In this case, the misalignment cannot be ignored. In addition, when the same sample portion is imaged, it is considered that the positions of the acquired images may be misaligned depending on the changed imaging conditions. In this case, the misalignment cannot be ignored. In this embodiment, however, it is possible to acquire the excellent result even when such misalignments occur.

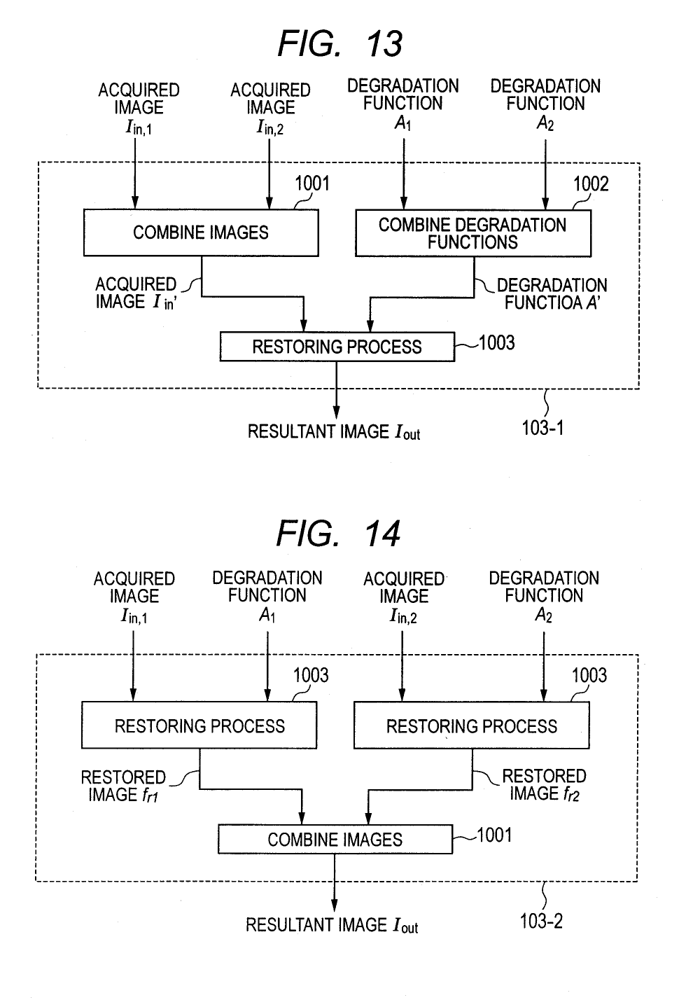

Next, the resolution improving process 103 is described with reference to FIGS. 13 to 15.

FIG. 13 is a flowchart of a resolution improving process 103-1 according to the present invention. The resolution improving process 103-1 according to the present invention is performed using an acquired image I_{in, 1}, an acquired image I_{in, 2}, a degradation function A₁ and a degradation function A₂. In this process, an image combining process 1001 is first performed on the acquired image I_{in, 1} and the acquired image I_{in, 2}. Then, a degradation function combining process 1002 is performed on the degradation function A₁ and the degradation function A₂. Lastly, a restoring process 1003 is performed on the combined acquired image I′ᵢₙ obtained by the image combining process and the combined degradation function A′ obtained by the degradation function combining process so as to obtain a resultant image Iₒᵤₜ 1315.

FIG. 14 is a flowchart of an example 103-2 of another process. In this example, the restoring process 1003 is performed on the acquired images using the degradation functions so as to obtain a restored image fᵣ₁ and a restored image fᵣ₂. Then, the image combining process 1001 is performed on the restored images fᵣ₁ and fᵣ₂ to obtain a resultant image Iₒᵤₜ 1415.

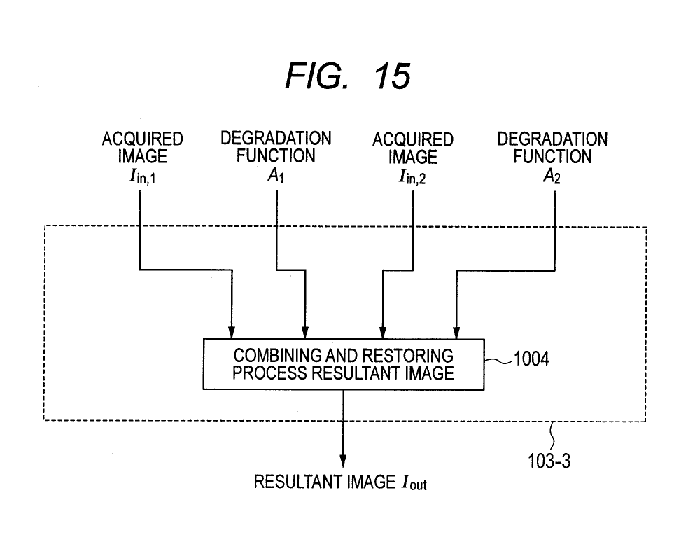

FIG. 15 is a flowchart of an example 103-3 of still another process. In this example, a combining and restoring process 1004 is performed on the acquired images I_{in, 1} and I_{in, 2} using the degradation functions A₁ and A₂ at one time so as to obtain a resultant image Iₒᵤₜ 1515. An image restoring process may be performed in the restoring process 1003 shown in FIGS. 13 and 14. However, the present invention is not limited to this. An edge enhancing process may be performed in the restoring process. In addition, a process that includes the image restoring process and the edge enhancing process may be performed in the restoring process.

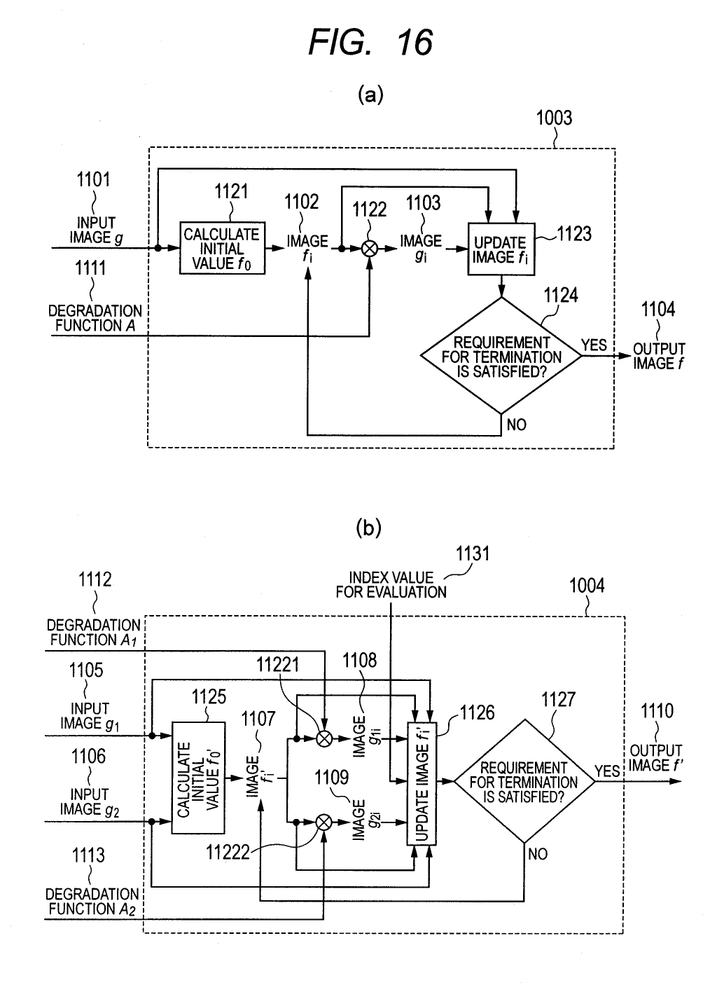

As an example of the restoring process 1003 and the combining and restoring process 1004, an example of an image restoring process according to the present invention is described with reference to FIGS. 16(a) and 16(b). The image restoring process according to the present invention is performed on the basis of an iterative method.

In general, an input image (normally acquired image) to be subjected to the restoring process can be represented by an image degradation model expressed by the following equation (Equation 1).

$$g ( x , y ) = {\sum }_{{x}^{′} , {y}^{′}}^{ } A ( x - {x}^{′} , y - {y}^{′} ) f ( x , y ) + n ( x , y ) \qquad ( Equation 1 )$$

where g(x, y) is the input image; f(x, y) is an output image (referred to as a restored image); A(x, y) is a degradation function; n(x, y) is a noise component; and (x, y) is coordinates of the position of a pixel. The noise component n(x, y) included in the equation is assumed as white noise in many cases. However, the noise component n(x, y) may be noise that is not independent from the output image f(x, y). In addition, the noise component n(x, y) may be noise other than noise that follows a Gaussian distribution. The noise component n(x, y) may be noise that follows a Poisson distribution. The noise may not be additive noise and may be multiplicative noise.

For the degradation functions according to the present invention, it is necessary to consider system characteristics of the charged particle microscope. Examples of causes that affect the degradation functions in the charged particle microscope are a probe current, the position of the focal point, and the aperture angle. The degradation functions can be accurately calculated by the calculation method disclosed in Non-Patent Document 2 using parameters related to the aforementioned causes.

When the edge enhancing process is used in the restoring process 1003 described with reference to FIGS. 13 and 14 and the combining and restoring process 1004 described with reference to FIG. 15, the degradation functions indicate parameters that represent the degree of edge enhancement. In this case, the degradation functions may be constants that do not vary depending on the position (x, y).

When the input image g(x, y) and the degradation function A(x, y) are known, the image restoring process can be performed on the basis of the iterative method. FIG. 16(a) shows an example of the image restoring process that is performed when a single image and a single degradation function are input. The iterative method is to repeat and update the image fᵢ(x, y) and to thereby increase the resolution and reduce noise so that the restored image f(x, y) is generated. First, in step 1121, an image f₀(x, y) that is an initial value of the image fᵢ(x, y) 1102 is generated using the input image g(x, y) 1101. The image f₀(x, y) may be the input image g(x, y) 1101. The image f₀(x, y) may be an image subjected to a pre-process such as a process of removing noise from the input image g(x, y) 1101. In addition, the image f₀(x, y) may be a restored image calculated by another image restoring process.

Next, in step 1122, an image g₀(x, y) that is the results of convolution of the image f₀(x, y) and the degradation function A is calculated. After that, in step 1123 of updating the image fᵢ(x, y), the image f₀(x, y) is updated using the input image g(x, y), the image f₀(x, y) and the image g₀(x, y) so that an image f₁(x, y) is acquired. After that, steps 1122 to 1124 are repeated to update the image fᵢ(x, y) 1102 until a requirement for termination is satisfied in step 1124. When the requirement for termination is satisfied in step 1124, the image fᵢ(x, y) 1102 is output as a restored image f(x, y) 1104. Satisfying the requirement for termination in step 1124 may mean that the image fᵢ(x, y) satisfies a specific requirement after the iteration is performed a certain number of times, or after a certain process time elapses, or when the amount of the image fᵢ(x, y) to be updated is reduced to a sufficiently small value.

For step 1123 of updating the image fᵢ(x, y), many methods have been proposed. For example, in Richardson-Lucy method that is widely known as an iterative method, the image fᵢ(x, y) is updated according to the following equation.

$${f}_{i + 1} ( x , y ) = {f}_{i} ( x , y ) {\sum }_{{x}^{′} , {y}^{′}}^{ } A ( - {x}^{′} , - {y}^{′} ) \frac{g ( x - {x}^{′} , y - {y}^{′} )}{{g}_{i} ( x - {x}^{′} , y - {y}^{′} )} \qquad ( Equation 2 )$$

In this method, the image fᵢ(x, y) converges to a maximum likelihood solution when noise follows a Poisson distribution. Non-Patent Document 3 describes the details.

FIG. 16b shows an example of the image restoring process that is performed when two images and two degradation functions are input. First, in step 1125, an image f₀′(x, y) that is an initial value of an image fᵢ′(x, y) is generated using an acquired input image gᵢ(x, y) 1105 and an acquired input image g₂(x, y) 1106. The image f₀′(x, y) may be the input image g₁(x, y) 1105, the input image g₂(x, y) 1106, or an image g(x, y) obtained by combining the input image g (x, y) 1105 and the input image g₂(x, y) 1106. For example, the image f₀′(x, y) may be an image subjected to a pre-process such as a process of removing noise from the image g(x, y). In addition, the image f₀′(x, y) may be a restored image calculated by another image restoring process.

Next, in step 11221, an image g₁₀(x, y) 1108 that is the results of convolution of the image f₀′(x, y) and a degradation function A₁ 1112 is calculated. In step 11222, an image g₂₀(x, y) 1109 that is the results of convolution of the image f₀′(x, y) and a degradation function A₂ 1113 is calculated. After that, in step 1126 of updating an image fᵢ′(x, y), the image f₀′(x, y) is updated using the input image g₁(x, y) 1105, the input image g₂(x, y) 1106, the image f₀′(x, y), the image g₁₀(x, y) 1108 and the image g₂₀(x, y) 1109 so that the image fᵢ′(x, y) is acquired. After that, steps 11221, 11222, 1126 and 1127 are repeated to update the image fᵢ′(x, y) until a requirement for termination is satisfied in step 1127. When the requirement for termination is satisfied in step 1127, the image fᵢ′(x, y) is output as a restored image f′(x, y) 1110. Satisfying the requirement for termination in step 1127 may mean that the image fᵢ′(x, y) satisfies a specific requirement after the iteration is performed a certain number of times, or after a certain process time elapses, or when the amount of the image fᵢ′(x, y) to be updated is reduced to a sufficiently small value.

In order to restore the image using the two acquired images and the two degradation functions, the following equation (Equation 3) that is obtained by changing Richardson-Lucy method can be used.

$${f}_{i + 1}^{′} ( x , y ) = {f}_{i}^{′} ( x , y ) [ d ( x , y ) {\sum }_{{x}^{′} , {y}^{′}}^{ } {A}_{1} ( - {x}^{′} , - {y}^{′} ) \frac{{g}_{1} ( x - {x}^{′} , y - {y}^{′} )}{{g}_{1 i} ( x - {x}^{′} , y - {y}^{′} )} + ( 1 - d ( x , y ) ) {\sum }_{{x}^{′} , {y}^{′}}^{ } {A}_{2} ( - {x}^{′} , - {y}^{′} ) \frac{{g}_{2} ( x - {x}^{′} , y - {y}^{′} )}{{g}_{2 i} ( x - {x}^{′} , y - {y}^{′} )} ] \qquad ( Equation 3 )$$

where d(x, y) is a weight for the image g₁(x, y) and the image g₂(x, y). The weight d(x, y) can be calculated using the following equation (Equation 4).

$$d ( x , y ) = \frac{k \times {h}_{1} ( x , y )}{{h}_{1} ( x , y ) + {h}_{2} ( x , y )} \qquad ( Equation 4 )$$

where h₁(x, y) is the image g₁(x, y) or a value to evaluate the resolution of the image g₁(x, y); h₂(x, y) is the image g₂(x, y) or a value to evaluate the resolution of the image g₂(x, y); and k is a constant. The index values h₁(x, y) and h₂(x, y) to evaluate the resolutions can be calculated by applying a resolution evaluating method (CG method disclosed in Patent Document 4) using a gradient of a concentration for each of local regions of an image to a local region that includes a pixel that correspond to a position (x, y).

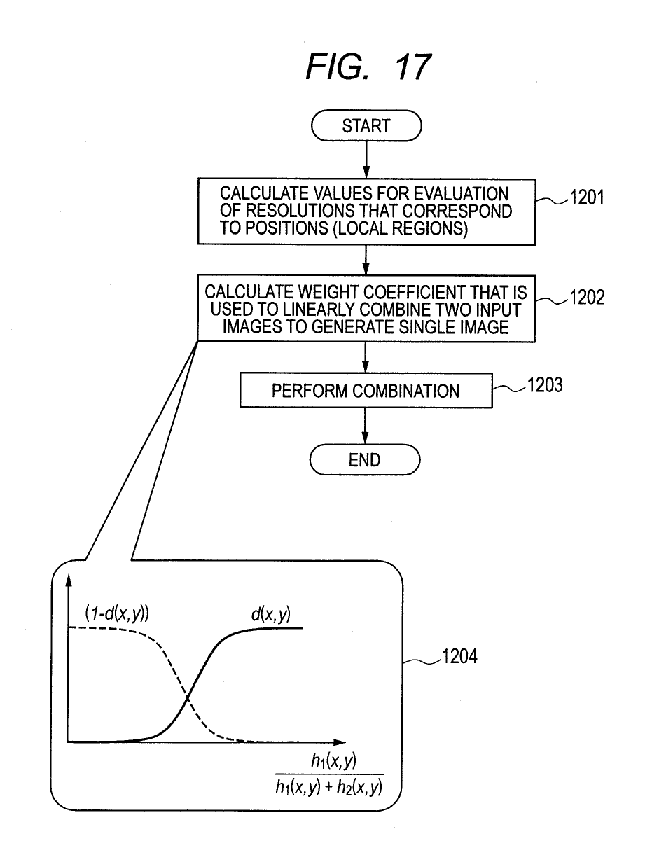

Next, procedures of the image combining process 1001 shown in FIGS. 13 and 14 are described with reference to FIG. 17. First, in step 1201, the values h₁(x, y) and h₂(x, y) to evaluate resolutions of local regions of the images are calculated. After that, in step 1202, a weight coefficient d(x, y) to combine the two images is calculated. Lastly, in step 1203, the two input images are combined to generate a single image according to the following Equation 5.

Iₒᵤₜ(x,y)=(x,y)=d(x,y)×I_{in,1}(x,y)+(1−d(x,y))×I_{in,2}(x,y) (Equation 5)

In this case, d(x, y) can be calculated using Equation 4 and may have a non-linear relationship with a value of;

(h₁(x,y)/h₁(x,y)+h₂(x,y)) (Equation 6)

as shown in a graph 1204.

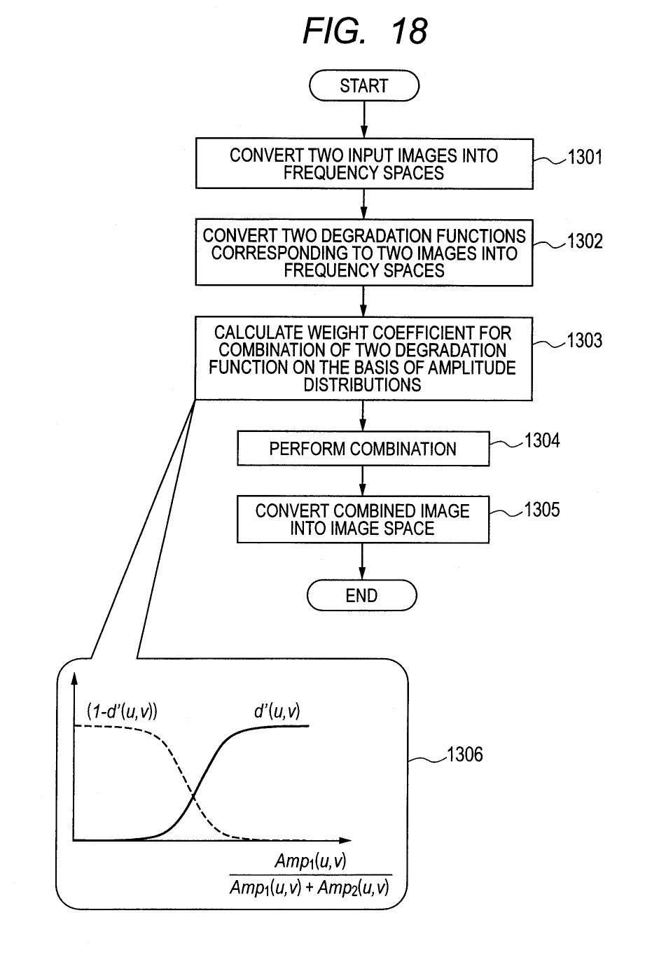

FIG. 18 shows another example of procedures of the image combining process. First, in step 1301, the two images are converted into frequency spaces. Next, in step 1302, the two degradation functions that correspond to the two images are converted into frequency spaces. Then, in step 1303, a weight coefficient d′(u, v) is calculated on the basis of amplitude distributions Amp₁(u, v) and Amp₂(u, v) of the two degradation functions. In this case, u and v are frequencies in x and y directions, respectively.

Then, the two images are combined to form a single image according to an equation that is similar to Equation 5. After that, in step 1305, the combined image is converted into a real space. In this case, d′(u, v) can be calculated using a value of;

(Amp₁(u,v)/Amp₁(u,v)+Amp₂(u,v)) (Equation 7)

as shown in a graph 1306.

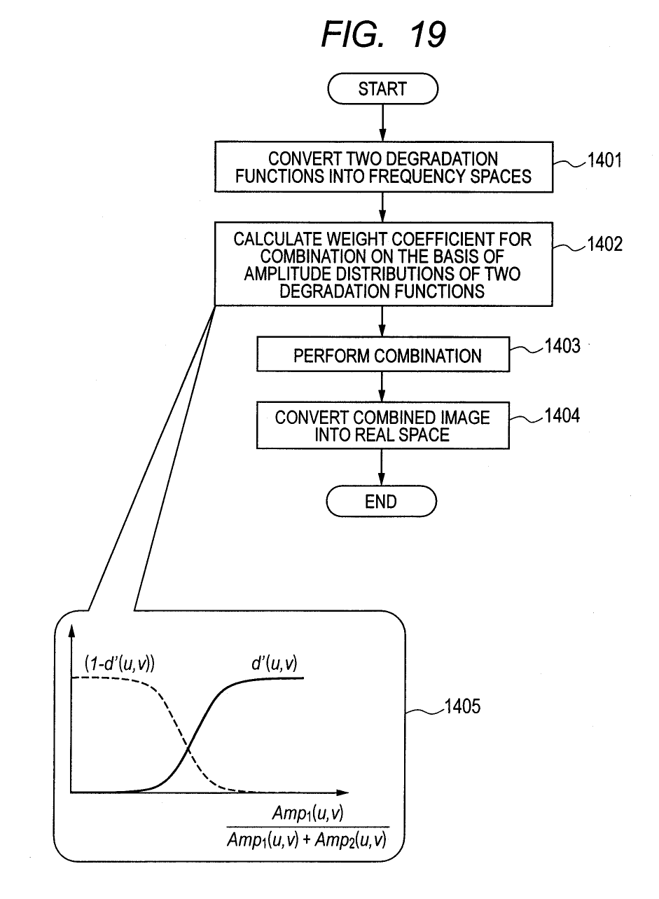

Next, an example of the degradation function combining process 1002 shown in FIG. 13 is described with reference to FIG. 19. First, in step 1401, the two degradation functions are converted into frequency spaces.

Next, in step 1402, the weight coefficient d′(u, v) is calculated on the basis of the amplitude distributions of the degradation functions in the same manner as step 1303 described with reference to FIG. 18. Then, the degradation functions are combined according to an equation that is similar to Equation 5 in step 1403. After that, the combined degradation function is converted into a real space in step 1404.

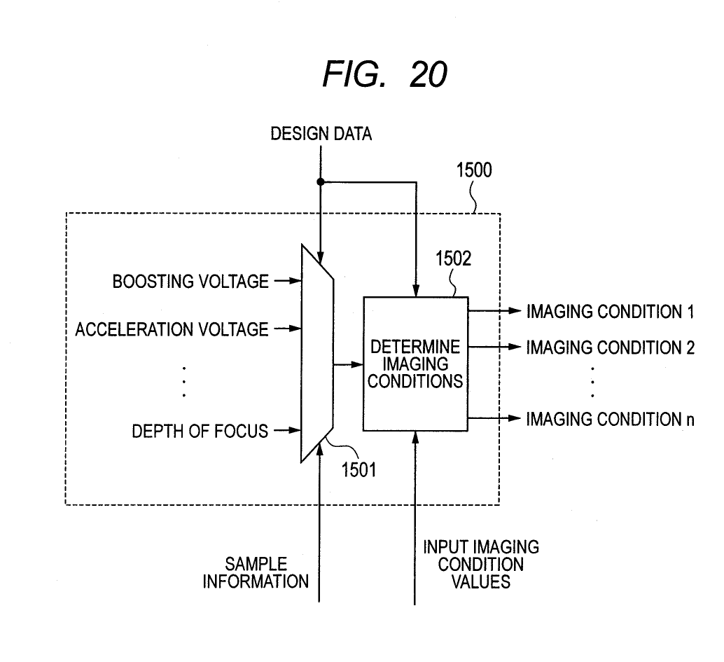

Next, an example of an interface (according to the present invention) that switches imaging conditions on the basis of design data and sample information is described with reference to FIG. 20. A target item to be switched is determined by a switch 1501 on the basis of the provided design data and the provided sample information. As the target item to be switched, a boosting voltage, an acceleration voltage, the depth of focus, or the like is determined, for example. Then, in step 1502 of determining an imaging condition, imaging conditions 1 to n that are used for imaging operations are determined on the basis of the design data and input imaging condition values. The input imaging condition values may be default values prepared in advance. In addition, the input imaging condition values may be values set by a user. In the imaging condition determining step, a value that varies depending on the design data or the input imaging condition value is set for the target item among the imaging conditions. The same value is set for each of items other than the target item. A plurality of target items may be determined.

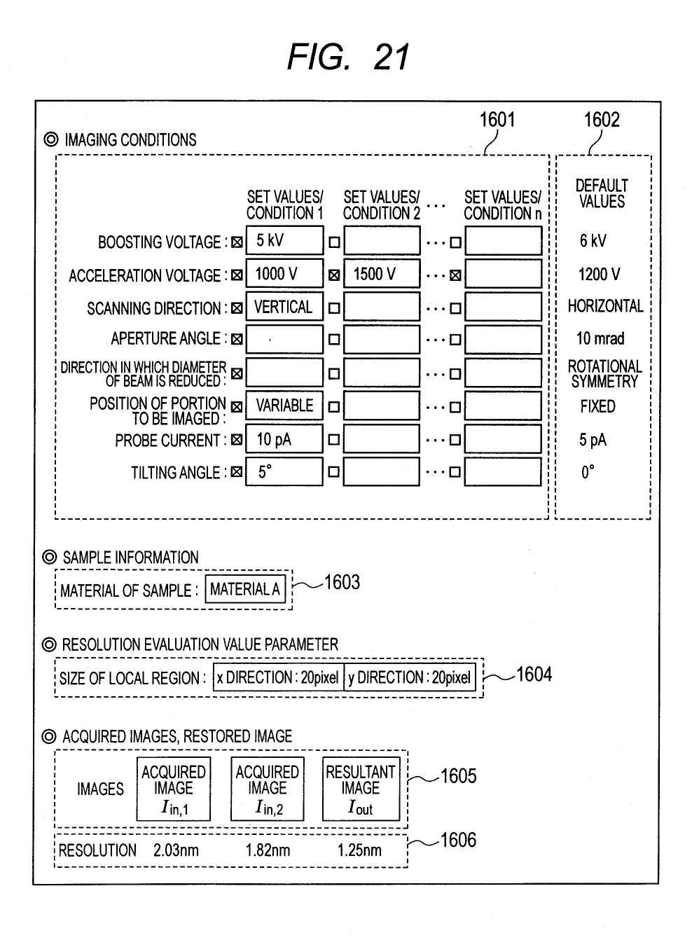

FIG. 21 shows an example of a GUI screen that prompts the user to set the imaging conditions. Different multiple imaging conditions can be set on the GUI screen. Reference numeral 1601 indicates a region for setting the imaging conditions. Whether to set the imaging conditions is determined using checkboxes that are located in front of condition setting fields for the imaging conditions in a column for the condition 1. Specifically, when a certain imaging condition needs to be set, a checkbox that corresponds to the certain imaging condition is checked with a symbol X. Specific numbers are set in the condition setting fields located on the right side of the checkboxes. When the imaging conditions are not set, default values 1602 are used. For columns for the imaging conditions 2 to n, checkboxes that are the same as the checkboxes for the condition 1 are provided. For the columns for the imaging conditions 2 to n, condition setting fields that are the same as the condition setting fields for the condition 1 and are used to set specific conditions are provided. A method for changing and setting the imaging conditions 2 to n is the same as the method for changing and setting the imaging condition 1.

In order to change the acceleration voltage, the checkboxes that correspond to the condition setting fields for the acceleration voltage and are provided for the conditions 2 to n are checked, and specific conditions are entered in the condition setting fields. In the case shown in FIG. 21, the other conditions are fixed; the acceleration voltage is set to 1000V and 1500V; and two images are acquired. The region 1601 is not limited to this example. For example, the interface that switches the imaging conditions using the design data as described in the example of FIG. 20 may be used.

The GUI screen shown in FIG. 21 includes a region 1603 that is used to set the sample information. In addition, the GUI screen shown in FIG. 21 may include a region 1604 that is used to specify the size of a local region in order to calculate a value to evaluate a resolution. In order to intuitively view an effect of a resolution improved by the method according to the present invention, the GUI screen may include an image display region 1605 and a region 1606 that displays resolution values. The image display region 1605 displays the acquired images and the resultant image.

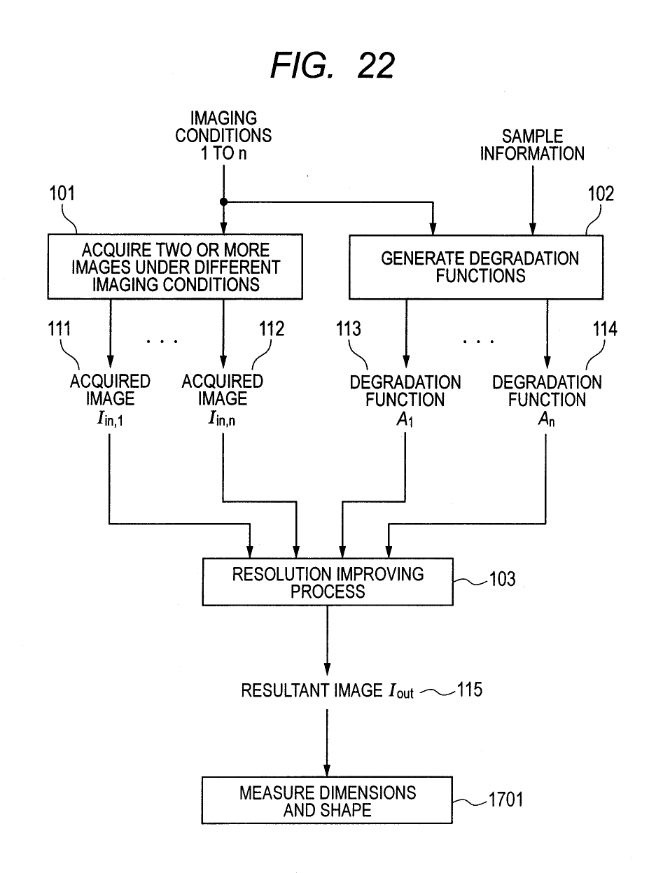

When the image with the improved resolution is used, dimensions and a shape can be measured with high accuracy. FIG. 22 is a flowchart of an example of a process of measuring the shape and dimensions of a pattern using the single clear and high-resolution image generated in the resolution improving process from two or more different acquired images in a semiconductor-measuring SEM such as a length measuring SEM. Sequences 101 to 103 are the same as steps 101 to 103 shown in FIG. 1. The shape and dimensions of a pattern included in the resultant image Iₒᵤₜ 115 subjected to the resolution improving process are measured in step 1701.

The length measuring SEM acquires images by detecting secondary electrons. An edge of a pattern included in a semiconductor sample is represented as a white band (linear region with a high brightness value) in each of the acquired images. The shape and dimensions of the pattern is measured using the white band.

However, as the resolution of the image is lower, the accuracy of the measurement is reduced due to an increase in the width of the white band. When the shape and dimensions of the pattern are measured using the image with the improved resolution, the accuracy of the measurement can be improved.

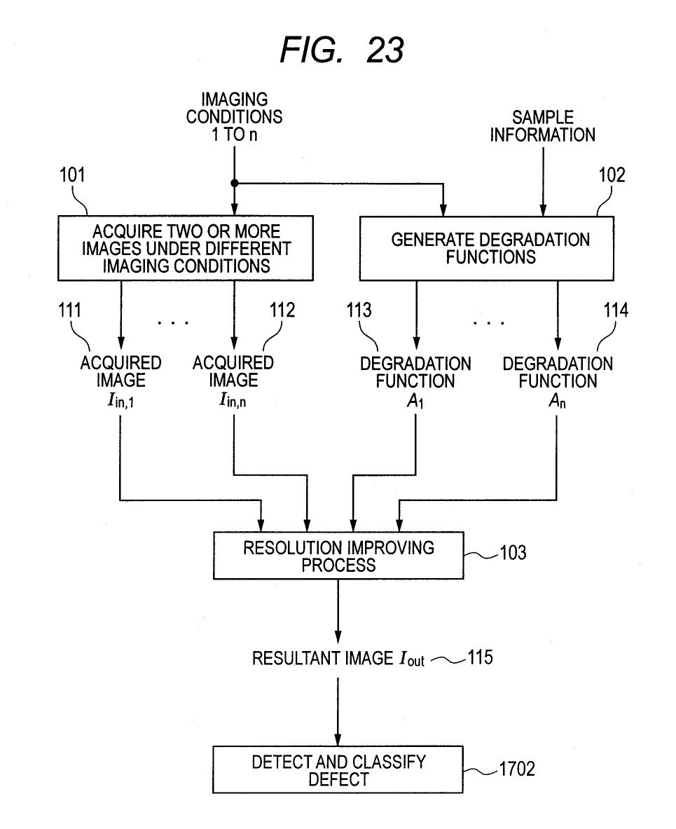

FIG. 23 is a flowchart of an example of a process of detecting and classifying a defect using a single clear and high-resolution image generated in the resolution improving process from two or more different acquired images in a semiconductor-inspecting SEM such as a SEM inspecting device or a defect reviewing SEM. Sequences 101 to 103 are the same as steps 101 to 103 shown in FIG. 1. A defect is detected and classified in step 1702 using the resultant image Iₒᵤₜ 115 subjected to the resolution improving process. It is not easy to detect a fine defect using a conventional acquired image since the resolution of the image is reduced. Thus, when the resolution of the acquired image is improved, a defect is noticeable and easily detected. In addition, when the resolution of the acquired image is improved, features of the image are clear. Thus, the defect is easily classified in step 1602.

1. A method for improving a resolution of an image of a sample which is acquired by a scanning charged particle microscope and processing the improved resolution image, acquiring images, generating an image with an improved resolution from the acquired images and processing the generated image, the method comprising the steps of:
image acquiring step for imaging a sample under different imaging conditions and acquiring multiple images of the sample;
degradation function generating step for generating degradation functions corresponding to the images acquired in the image acquiring step respectively;
improved resolution image generating step for generating an image with an improved resolution using the multiple images acquired in the image acquiring step and the degradation functions that correspond to the acquired images which have been generated in the degradation function generating step; and
image processing step for processing the improved resolution image.

2. The method for processing the image acquired by the scanning charged particle microscope according to claim 1,
wherein the image acquiring step, the different imaging conditions are set by changing a boosting voltage.

3. The method for processing the image acquired by the scanning charged particle microscope according to claim 1,
wherein the image acquiring step, the different imaging conditions are set by changing an acceleration voltage to be applied to a charged particle beam.

4. The method for processing the image acquired by the scanning charged particle microscope according to claim 1,
wherein the image acquiring step, the different imaging conditions are set by changing a scanning direction of a charged particle beam.

5. The method for processing the image acquired by the scanning charged particle microscope according to claim 1,
wherein the image acquiring step, the different imaging conditions are set by changing a frequency distribution of an intensity waveform of a beam incident on the surface of the sample.

6. The method for processing the image acquired by the scanning charged particle microscope according to claim 1,
wherein the image acquiring step, the different imaging conditions are set by changing a direction in which the diameter of the intensity waveform of a beam incident on the surface of the sample is minimized.

7. The method for processing the image acquired by the scanning charged particle microscope according to claim 1,
wherein the image acquiring step, the different imaging conditions are set by changing a depth of focus.

8. The method for processing the image acquired by the scanning charged particle microscope according to claim 1,
wherein the image acquiring step, the different imaging conditions are switched on the basis of design data.

9. The method for processing the image acquired by the scanning charged particle microscope according to claim 1,
wherein a feature of the sample to be imaged is at least one of the shape of a pattern, a dimension of the pattern, information on whether or not a defect is present, the position of the defect, and the type of the defect.

10. A scanning charged particle microscope comprising:
image acquiring means for scanning and irradiating a sample with a charged particle beam focused on the sample, detecting secondary charged particles generated from the sample to image the sample, and acquiring images of the sample;
image acquiring condition controlling means for controlling the image acquiring means so that the image acquiring means acquires multiple images under different imaging conditions;
degradation function generating means for generating degradation functions corresponding to the multiple images respectively acquired under the different imaging conditions by the image acquiring means controlled by the image acquiring condition controlling means;
improved resolution image generating means for generating an image with an improved resolution using the multiple images that is acquired under the different imaging conditions by the image acquiring means controlled by the image acquiring condition controlling means, and the degradation functions that is generated by the degradation function generating means and corresponds to the multiple images; and
image processing means for processing the image with the resolution improved by the improved resolution image generating means.

11. The scanning charged particle microscope according to claim 10,
wherein the image acquiring condition controlling means controls a boosting voltage of the image acquiring means, and changes an image condition under which the sample is imaged by the image acquiring means.

12. The scanning charged particle microscope according to claim 10,
wherein the image acquiring condition controlling means controls an acceleration voltage to be applied to the charged particle beam with which the sample is irradiated and scanned by the image acquiring means, the image acquiring condition controlling means changing an imaging condition under which the sample is imaged by the image acquiring means.

13. The scanning charged particle microscope according to claim 10,
wherein the image acquiring condition controlling means controls a scanning direction of the charged particle beam with which the sample is irradiated and scanned by the image acquiring means, the image acquiring condition controlling means changing an imaging condition under which the sample is imaged by the image acquiring means.

14. The scanning charged particle microscope according to claim 10,
wherein the image acquiring condition controlling means controls a frequency distribution of an intensity waveform of the charged particle beam incident on the surface of the sample, and changes an imaging condition under which the sample is imaged by the image acquiring means, the charged particle beam being used by the image acquiring means to irradiate and scan the sample.

15. The scanning charged particle microscope according to claim 10,
wherein the image acquiring condition controlling means controls a direction in which the diameter of the intensity wave of the charged particle beam incident on the surface of the sample is minimized, and changes an imaging condition under which the sample is imaged by the image acquiring means, the charged particle beam being used by the image acquiring means to irradiate and scan the sample.

16. The scanning charged particle microscope according to claim 10,
wherein the image acquiring condition controlling means controls the depth of focus of the charged particle beam with which the sample is irradiated and scanned by the image acquiring means, the image acquiring condition controlling means changing an imaging condition under which the sample is imaged by the image acquiring means.

17. The scanning charged particle microscope according to claim 10,
wherein the image acquiring condition controlling means changes, on the basis of design data, an image condition under which the sample is imaged by the image acquiring means.

18. The scanning charged particle microscope according to claim 10,
wherein the image processing means processes the image with the resolution improved by the high-resolution image generating means, and
the image processing means processes the image with the resolution improved by the high-resolution image generating means and calculates at least one of the shape of the pattern, a dimension of the pattern, information on whether or not a defect is present in the pattern, the position of the defect, and the type of the defect which are as features of a pattern on the sample.
